(19) United States
(12) Patent Application Publication
(10) Pub. No.: US 2026/0147666 A1
(43) Pub. Date: May 28, 2026

(54) TWO-DIMENSIONAL INTERLEAVING OF ERROR CORRECTION CODE FOR BURST AND RANDOM ERROR CORRECTION IN TAPE STORAGE

(71) Applicant: INTERNATIONAL BUSINESS MACHINES CORPORATION, ARMONK, NY (US)

(72) Inventors: Roy Cideciyan, Rüschlikon (CH); Simeon Furrer, Altdorf (CH); Masayuki Iwanaga, TOKYO (JP); Mark Alfred Lantz, Adliswil (CH); Keisuke Tanaka, TOKYO (JP)

(21) Appl. No.: 18/960,783

(22) Filed: Nov. 26, 2024

(51) Int. Cl. G06F 11/10

(52) U.S. Cl. CPC G06F 11/10

(57) ABSTRACT

Provided are a method, system, and computer program product in which

data is encoded for a plurality of tracks of a tape of a tape drive, by using an error correction code (ECC) scheme that applies a single code with code word symbols that are at least 10 bits. The code word symbols are interleaved along and across parallel tracks of the tape in the tape drive.

### BACKGROUND

The disclosure relates to tape storage systems, and more specifically relates to two-dimensional interleaving of error correction code for burst and random error correction in tape storage.

Linear Tape-Open (LTO), is a magnetic tape data storage technology used for backup, data archiving, and data transfer. In certain tape drives, variable-length blocks of data are received from a host interface and converted into fixed units known as data sets. These data sets are typically broken down into smaller fixed units known as sub data sets (SDS). Error correction coding is then performed on these sub data sets as a unit to protect the data contained therein.

To protect data in an SDS, conventional tape drives may organize a SDS into a two-dimensional array made up of rows and columns. Each row in the two-dimensional array may be made up of multiple (e.g., 2 or 4) interleaved data words. Error correction codes may then be generated for each row in the array and each column in the array to protect the data contained therein. This provides two dimensions of protection for data in the array since protection is provided for both the rows and columns. The two orthogonal error correcting codes corresponding to the rows and columns are typically referred to as C1 and C2 code, respectively. The C1 code is used to detect and correct errors in the rows of the SDS and the C2 code is used to detect and correct errors in the columns of the SDS. Once generated, the C1 and C2 error correction codes may be appended to the array for eventual storage on the magnetic tape medium. For example, when systematic Reed-Solomon Codes are used for C1 and C2, each C1 (or C2) codeword contains “data” and “parity” symbols. Encoding a C1 (or C2) codeword means that for the input data symbols, a number of parity symbols are generated, and the concatenation of the input data and the parity symbols represents the codeword.

Reed-Solomon (RS) codes are a group of error-correcting codes that may be used for protection of data. RS codes operate on a block of data treated as a set of finite-field elements called symbols. Reed-Solomon codes are able to detect and correct multiple symbol errors.

### SUMMARY OF THE PREFERRED EMBODIMENTS

Provided are a method, system, and computer program product in which data is encoded for a plurality of tracks of a tape of a tape drive, by using an error correction code (ECC) scheme that applies a single code with code word symbols that are at least 10 bits. The code word symbols are interleaved along and across parallel tracks of the tape in the tape drive.

In certain embodiments, the code word symbols are equally distributed along and across the parallel tracks.

In further embodiments, an ECC code rate is at most ⅞ to correct up to 4 out of 32 dead tracks.

In additional embodiments, the ECC scheme comprises a single Reed-Solomon code with code word symbols of 10 or more bits.

In further embodiments, the tape drive is a multi-track tape drive of 32 or more tracks and includes 64 track tape drives and 128 track tape drives.

In yet further embodiments, a minimum physical spacing between the symbols of an ECC code word is of an order of 0.5 millimeter or more.

In certain embodiments, an ECC overhead is reduced without degrading burst error correction and random error correction capability of other ECC schemes that are used in tape drives.

### BRIEF DESCRIPTION OF THE DRAWINGS

Referring now to the drawings in which like reference numbers represent corresponding parts throughout:

FIG. 1 illustrates a block diagram of a computing environment comprising a host computational device that is coupled to a tape drive, in accordance with certain embodiments;

FIG. 2 illustrates a block diagram that depicts how data is recorded on a magnetic tape, in accordance with certain embodiments;

FIG. 3 illustrates a block diagram that depicts the data flow from the host to the tape, in accordance with certain prior art mechanisms;

FIG. 4 illustrates a block diagram of a product error correction code, in accordance with certain prior art mechanisms;

FIG. 5 illustrates a block diagram that shows Codeword Interleave-4 (CWI-4) elements in sub data set and data set in 64-channel systems, in accordance with certain prior art mechanisms;

FIG. 6 illustrates a block diagram that shows sub data set in C0 ECC scheme for 64 channels, in accordance with certain embodiments;

FIG. 7 illustrates a block diagram that shows deep interleaving of C0 ECC codewords symbols on tape, in accordance with certain embodiments;

FIG. 8 illustrates a block diagram that shows corner-to-corner distances verses center-to-center distances, in accordance with certain embodiments;

FIG. 9 illustrates a block diagram that shows format efficiency of C0 ECC, in accordance with certain embodiments;

FIG. 10 illustrates a flowchart that shows exemplary operations, in accordance with certain embodiments; and

FIG. 11 illustrates a block diagram of a system that shows certain elements that may be included in a controller, a tape drive, and a host computational device as described in FIGS. 1-10, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Several examples will now be provided to further clarify various aspects of the present invention:
Example 1; A method in which data is encoded for a plurality of tracks of a tape of a tape drive, by using an error correction code (ECC) scheme that applies a single code with code word symbols that are at least 10 bits. The code word symbols are interleaved along and across parallel tracks of the tape in the tape drive. As a result, improvements are made to mechanisms for storing data on the tape of a tape drive.

Example 2: The limitations of Example 1, in which the code word symbols are equally distributed along and across the parallel tracks. As a result, the code word symbols that are equally distributed along the parallel tracks are used to improve mechanisms for storing data on the tape of a test drive.

Example 3: The limitations of any of Examples 1-2, in which ECC code rate is at most ⅞ to correct up to 4 out of 32 dead tracks. As a result, up to 4 out of 32 dead tracks are corrected in certain embodiments.

Example 4: The limitations of any of Examples 1-3, in which the ECC scheme comprises a single Reed-Solomon code with code word symbols of 10 or more bits. As a result, a single Reed-Solomon code with code word symbols of 10 or more bits are used to improve mechanisms for storing data on the tape of a test drive.

Example 5: The limitations of any of Examples 1-4, where the tape drive is a multi-track tape drive of 32 or more tracks and includes 64 track tape drives and 128 track tape drives. As a result, improved mechanisms for data storage on tape drives of 32 or more tracks are provided.

Example 6: The limitations of any of Examples 1-5, where a minimum physical spacing between the symbols of an ECC code word is of an order of 0.5 millimeter or more. As a result, the symbols of the ECC codes word are separated by a minimum physical spacing to improve mechanisms for storing data on the tape of a tape drive.

Example 7: The limitations of any of Examples 1-6, where an ECC overhead is reduced without degrading burst error correction and random error correction capability of other ECC schemes that are used in tape drives. As a result, there is a reduction in ECC overhead while storing data on tape.

Example 8: A tape drive, comprising, a controller, and a tape head coupled to the controller, where the controller is configured to perform a method according to any of Examples 1-7. As a result, improvements are made to mechanisms for storing data on the tape of a tape drive.

Example 9: A computer program product comprising a computer readable storage medium having computer readable program code embodied therewith, where the computer readable program code when executed is configured to perform a method according to any of Examples 1-7. As a result, improvements are made to mechanisms for storing data on the tape of a tape drive.

Data cartridge capacity has been doubling approximately every few years since the introduction of LTO cartridges in 2000. This fact is critical for the success of magnetic tape storage technology. Data cartridge capacity may be increased by: (a) increasing track density; (b) increasing linear density; (c) increasing the length of magnetic tape in a cartridge, i.e., decreasing thickness of magnetic tape; and (d) increasing the format efficiency, i.e., reducing tape layout overhead. As the cartridge capacities increase, it gets more difficult to increase linear and track densities and reduce tape thickness. Therefore, it is important to reduce overhead as much as possible without performance degradation.

If mechanisms do not consider the overhead on magnetic tape due to rewrite (about 3% of tape is usually reserved for rewrite), the overhead in magnetic tape storage is currently around 22%, i.e., out of every 100 bits written on magnetic tape 78 bits represent user information (compressed or uncompressed). By far the largest part of this overhead corresponding to about 17% is due to error correction coding (ECC). There is a need for an efficient ECC scheme that reduces the ECC overhead without degrading the burst error correction and random error correction capability of the ECC code and certain embodiments provided in this disclosure addresses these and other related problems.

Certain embodiments present a new ECC scheme (referred to as C0 ECC scheme) for magnetic tape storage that results in a significant increase of cartridge capacity by 5.9% or more without degrading burst error performance of the ECC scheme that is currently used in tape drives and providing a similar random error performance.

The current ECC scheme protecting data is also responsible for header protection and rewrite. In next-generation tape drives, there may be separate powerful mechanisms independent of (decoupled from) data ECC that provide header protection and rewrite, thus allowing a new approach to data ECC. Certain embodiments distribute the symbols of a powerful cross-track and along-track ECC code as far apart from each other as possible within a Data Set. The new ECC codes have a code rate of ⅞=0.875, which ensures that their burst error correction performance remains the same as in currently used tape formats. Their random error correction capability is similar to the random error correction capability of product codes currently used in tape drives.

The ECC scheme in LTO and certain other tape drives rely on a product ECC scheme consisting of two Reed-Solomon (RS) codes also known as C1 and C2 codes. Four-way byte-interleaved C1 codewords (CWI-4) are written on each track, whereas bytes of C2 codewords are distributed as far apart as possible within a Data Set.

The use of C1 RS code enables rewrites, protects headers and improves error-rate performance. Rewrite decisions after C1 decoding has been essential for rewriting. Along-track header protection has been integrated/coupled with data ECC since LTO7. Good error-rate performance in conjunction with C2 code is obtained even without iterative decoding. Iterative decoding of the product code results in further improvement of the error-rate performance. The use of C2 RS code in conjunction with deep interleaving is essential because of burst error correction. Correction of up to ⅛ of all tracks is performed, e.g. 4 dead tracks out of 32 tracks, provided that C2 RS code rate is at most ⅞=0.875. Correction of stripe errors, and correction of localized media defects are performed. Good random-error performance of C2 code in conjunction with C1 code and deep interleaving is obtained.

For certain embodiments it is observed that rewriting based on Run-length-limited (RLL) decoding errors and cross-track header ECC decoupled from data ECC make C1 coding non-essential.

In certain embodiments, the use of only one powerful C0 RS code alone for ECC allows a significant reduction in ECC overhead by increasing the ECC code rate from 0.83125 to 0.875. Such a reduction in ECC overhead from about 17% to 12.5% directly leads to an increase in cartridge capacity.

Certain embodiments distribute the symbols of a powerful ECC code C0 as far apart from each other as possible in a two-dimensional Data Set such that the burst and random error correction capabilities preferably remain the same. Rewriting decisions are based on RLL decoding errors and cross-track header ECC that is decoupled from data ECC protects the headers.

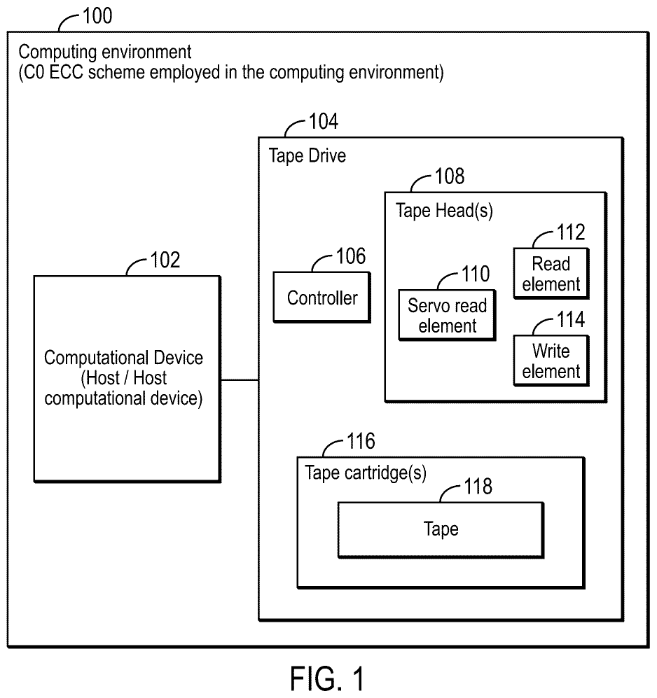

FIG. 1 illustrates a block diagram of a computing environment 100 comprising a computational device 102 that is coupled to a tape drive 104, where the computational device 102 may also be referred to as a host or a host computational device. A C0 ECC scheme is employed in the computing environment, in accordance with certain embodiments. The host computational device 102 may comprise any suitable computational device known in the art, such as a desktop computer, a laptop, a client, a telephony device, a server, etc. The tape drive 104 includes a controller 106, tape heads 108 comprising one or more servo read elements 110 (also referred to as servo element), one or more read elements 112, and one or more write elements 114. A tape cartridge 116 is included in the tape drive 104, and the tape cartridge 116 may include a tape 118 that may comprise a magnetic tape.

The tape drive 104 may be coupled to the host computational device 102 either directly or via a network. In certain embodiments the tape drive 104 may reside within the host computational device 102.

The controller 106 included in the tape drive 104 controls the movement of the tape heads 108 and upon request from the host computational device 102 may write data to the tape 118 or may read data from the tape 118.

Error Correction Codes (ECC) are used for data storage in the tape 118 to achieve very low bit error rates under normal operating conditions. Linear block codes, such as Reed-Solomon (RS) codes and low-density parity-check (LDPC) codes, may comprise the ECC schemes used for tape in existing mechanisms. In certain embodiments, a C0 ECC scheme is used in the computing environment 100.

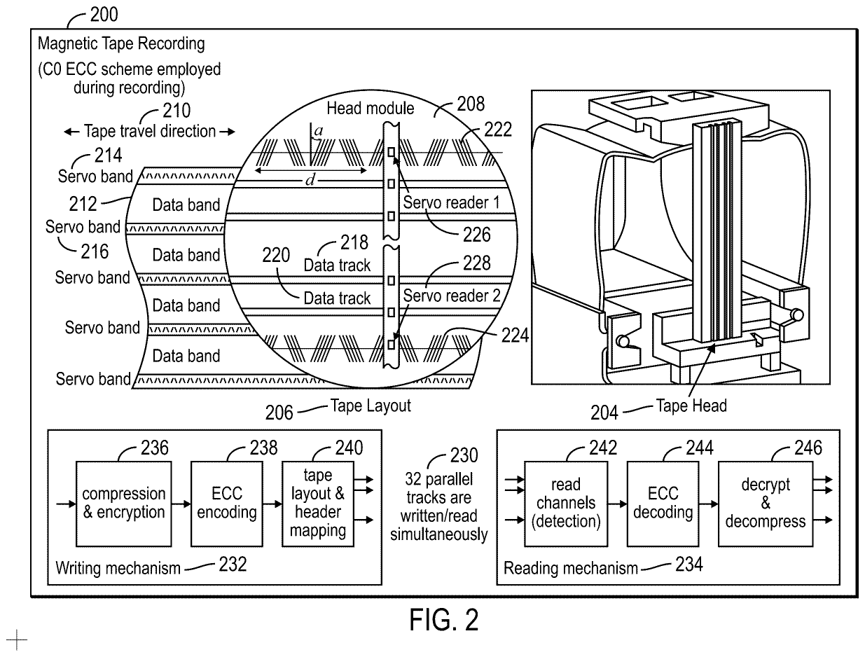

FIG. 2 shows a block diagram 200 that depicts how data is recorded on a magnetic tape, in accordance with certain embodiments, wherein a C0 ECC scheme is employed during recording. The magnetic tape may also be referred to as a tape. The tape may comprise a plastic film with a magnetic layer on top of the plastic film, where the magnetic layer may be referred to as the recording layer. Other types of tapes may also be possible.

The tape head 204 shown in FIG. 2 is comprised of three modules comprising one or more write elements, one or more read elements, and one or more servo elements. The write element writes, and behind the write element is a read element to verify that that the data has been written properly to tape. One write module is active in the forward direction of tape movement and the other write module is active in the backward direction of tape movement. The read module may be positioned in between two write modules and is used for reading data. The servo elements read prewritten servo bands to ensure that the tape head is positioned correctly with respect to the tape for reading and writing. Various configurations and number of read, write and servo elements may be found in different types of tape heads.

A tape layout 206 along with a magnified section 208 of the tape layout 206 is shown in FIG. 2. The tape may move in the forward direction or backward direction as shown via reference numeral 210. A plurality of data bands 212 separated by servo bands 214, 216 may be present in the tape.

The magnified section 208 of the tape layout 206 shows that each data band is comprised of a plurality of data tracks 218, 220 written within the region between two servo patterns 222, 224, where the servo patterns 222, 224 form servo tracks. In certain embodiments the plurality of simultaneously recorded data tracks 218, 220 may be 32 in number. The data tracks 218, 220 are also referred to as tracks, and the servo tracks including the servo patterns 222, 224 correspond to servo bands. The two servo readers 226, 228 read the servo patterns 222, 224 to ensure that the positioning of the tape head with respect to the tape is correct for reading or writing data. The servo patterns 222, 224 are prewritten by the tape manufacturer.

FIG. 2 shows that in certain embodiments 32 parallel tracks may be written or read simultaneously (reference numeral 230). The operations for the corresponding writing mechanism 232 and reading mechanism 234 are also shown in FIG. 2.

In the writing mechanism 232, the data received from the host 102 first undergoes compression and encryption (as shown via reference numeral 236). The compressed and encrypted data then undergoes ECC encoding (as shown via reference numeral 238). Then the ECC encoded data is written to tape with appropriate headers (as shown via reference numeral 240). In certain embodiments, a C0 ECC scheme is employed for encoding data.

In the reading mechanism 234, the operations start with the read channels detecting the written data and headers on the tape (shown via reference numeral 242). The read channels consist of magneto-resistive read elements, amplifiers and data channels that together detect bits written on tape. Then, ECC decoding is performed (as shown via reference numeral 244) to detect and correct errors, followed by decryption and decompression (as shown via reference numeral 246) to determine the data.

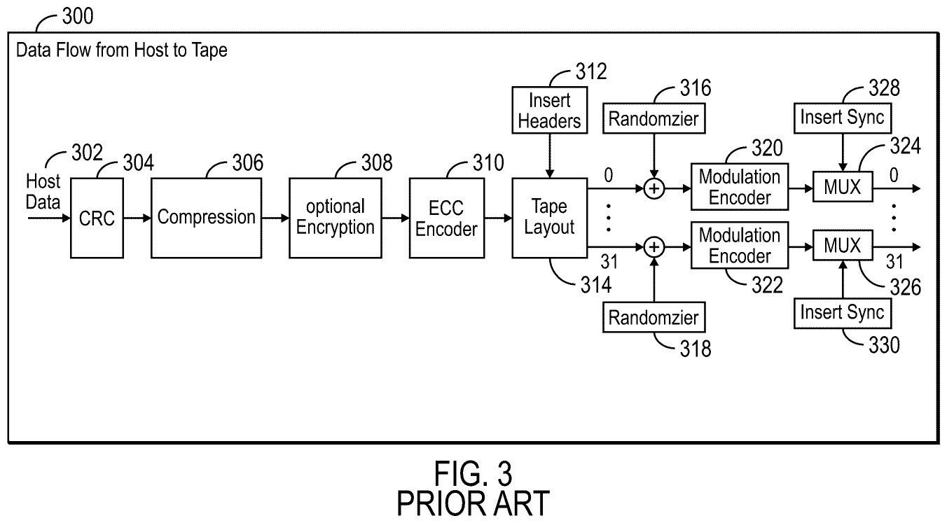

FIG. 3 shows a block diagram 300 that depicts the data flow from the host 102 to the tape 118 in accordance with certain prior art mechanisms. FIG. 3 shows a system for encoding data in a tape drive with 32 simultaneously written tracks. Any number of tracks may be written to a magnetic medium, such as 4 tracks, 8 tracks, 16 tracks, 32tracks, 64 tracks, etc. Furthermore, in certain embodiments any type of storage medium may be used, such as magnetic tape, optical disk (such as CD-ROM, DVD-ROM, Blu-Ray, etc.), hard disk, etc.

The host data 302 received from the host 102 by the tape drive 104 first undergoes a cyclic redundancy check (CRC) 304 followed by a compression 306 and an optional encryption 308. Then at block 310 an ECC encoder is used to perform an ECC encoding, and an insertion of headers is performed at block 312 followed by the distribution of this data into 32 data streams to generate the tape layout 314. During the ECC encoding process, parity bytes are added to the data (e.g., via Reed-Solomon based two dimensional code for data protection), and the data is broken into small chunks, and each chunk is made to include a header before the chunk with the ECC encoded data and headers are written on the tape. There is a processing and storage overhead for performing ECC encoding of data and for writing the header.

The blocks shown in FIG. 3, also include scrambling (e.g., 32 randomizers numbered 0 to 31 adapted for data randomization in each channel shown via reference numerals 316, 318). Also shown are modulation encoders 320, 322, and individual channel multiplexers 324, 326 for inserting synchronization sequences/marks 328, 330 for each of the 32 tracks numbered 0 to 31.

In one approach, the storage medium on which ECC encoded data and headers are written may be a magnetic tape, and components of the system may comprise logic adapted for parsing the encoded data into a plurality of tracks prior to writing the encoded data to the magnetic tape.

In FIG. 3, the ECC encoder module 310 may be used for inserting a product code comprising Reed-Solomon codes into sub data sets (SDS). A fundamental data block having four interleaved codewords therein written on each track is referred to as a Codeword Interleave-4 (CWI-4). “Codeword Interleave” refers to more than one (four in the case of CWI-4) Reed-Solomon (RS) codewords being interleaved when they are written onto magnetic tape.

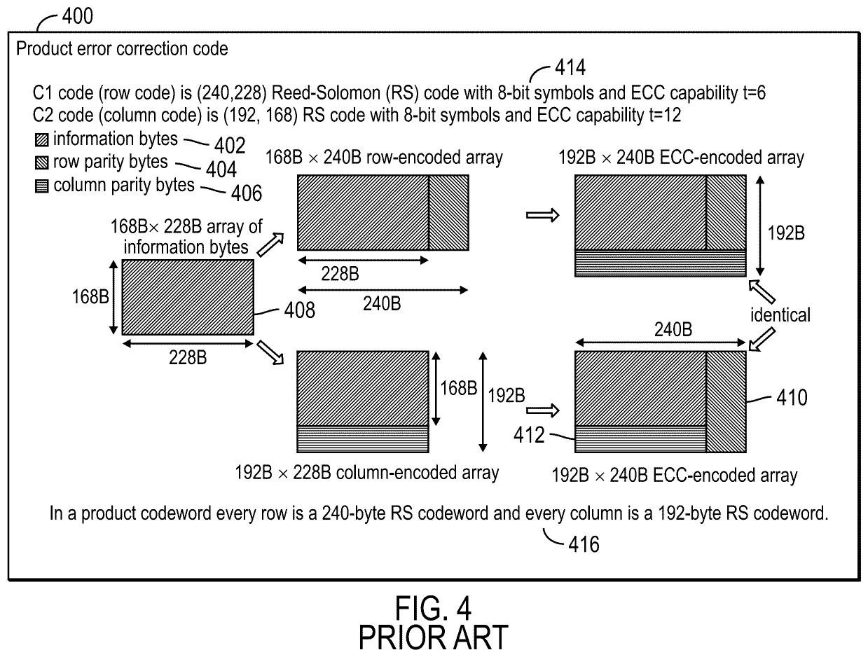

FIG. 4 illustrates a block diagram 400 of a product error correction code, in accordance with certain prior art mechanisms. User data to which parity bytes are added are shown in the block diagram 400. FIG. 4 shows how in certain mechanisms user data is logically transformed into product code words.

A legend showing information bytes 402, row parity bytes 404, and column parity bytes 406 are shown.

User data comprising information bytes 408 are shown. Row parity bytes 410 and column parity bytes 412 are shown to be added to the information bytes 408. The row parity bytes may comprise the parity of the C1 code, and the column parity bytes the parity of the C2 code.

The C1 code is a (240,228) RS code and the C2 code is a (192,168) RS code as shown via reference numeral 414. In a product codeword each row is a 240-byte RS codeword and every column is a 192-byte RS codeword as shown via reference numeral 416.

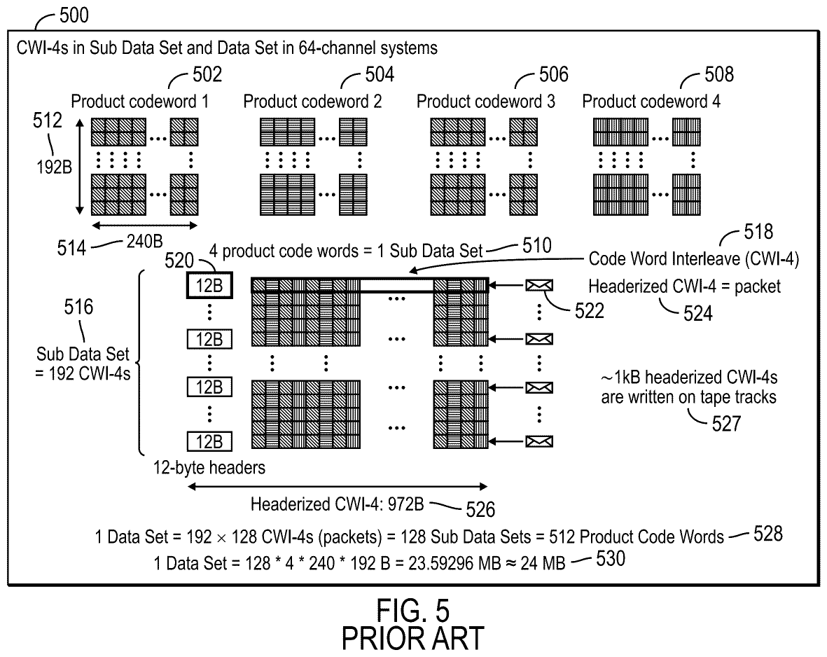

FIG. 5 illustrates a block diagram 500 that shows CWI-4s in sub data set and data set in 64-channel (track) systems, in accordance with certain prior art mechanisms.

In FIG. 5, four product codewords 502, 504, 506, 508 comprise a sub data set (as shown via reference numeral 510). While many different product codeword sizes are possible, in the example provided each product codeword is 192 bytes by 240 bytes as shown via reference numerals 512, 514. Each product code word is comprised of user data and parity bytes (ECC information).

A single sub data set 516 is formed of 192CWI-4 s, where each CWI-4 is a row 518 as shown. A 12-byte header 520 is added to each CWI-4 to generate a packet 522 that is also referred to as a headerized CWI-4 packet 524. The 12-byte header of a packet stores metadata of the data stored in the packet, including the location of the data. Each packet (i.e., headerized CWI-4) is about 1 kilobyte (actually 972 bytes which is slightly less than 1 kilobyte as shown via reference numeral 526 in FIG. 4).

Therefore, each sub data set has 192 rows and 972 columns of byte information (as shown via reference numerals 516 and 526). The number of columns are 972 because 4 codewords of 240 bytes together form 4×240, i.e., 960 bytes, and then 12 bytes of header information are added.

Therefore, FIG. 5 shows certain mechanisms in which product code words are assembled into a sub data set and how packets (headerized CWI-s) are formed where each packet has a 12-byte header.

FIG. 5 shows that mechanisms may be specifically for 64-channel systems where 972 bytes (i.e., approximately 1 kB) of headerized CWI-4s are written on tape tracks as shown via reference numeral 527. One data set is comprised of 128 sub data sets and 1 data set is approximately 24 MB as shown via reference numerals 528, 530.

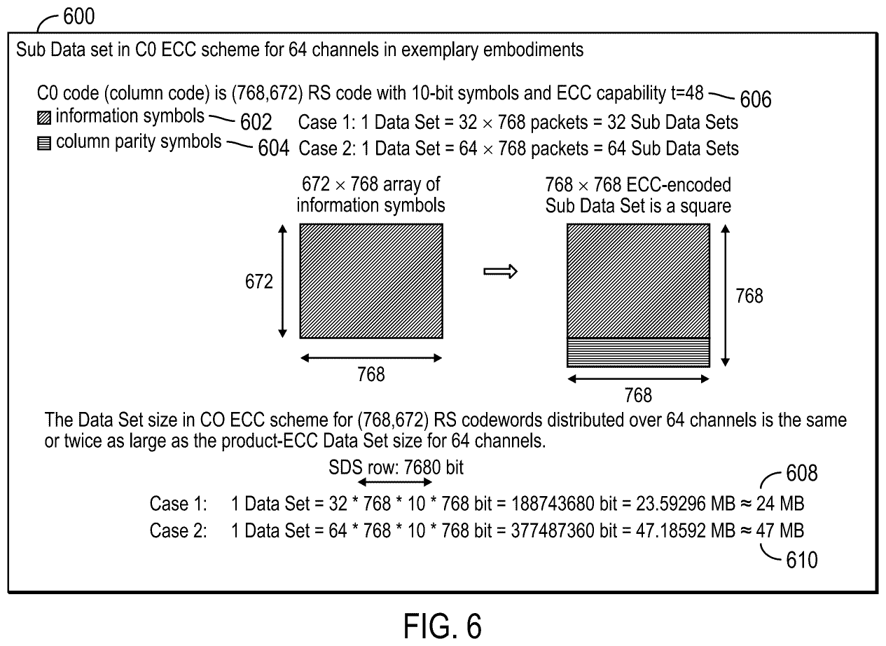

FIG. 6 illustrates a block diagram 600 that describes a sub data set and describes two data set options in a C0 ECC scheme for 64 channels, in accordance with certain embodiments.

In FIG. 6, instead of 8-bit symbols (bytes) used in previous schemes, 10-bit symbols are used, and the scheme is referred to as a C0 ECC scheme.

A legend shows the information symbols 602 and the column parity symbols 604, where the column parity symbols are constructed differently in FIG. 6, and there are no row parity symbols. Note that the construction of a Sub Data Set using the C0 ECC scheme is very different compared to the product ECC case in FIGS. 4, 5: The first 672 rows of 10-bit symbols are populated with information symbols. Subsequently, every column is encoded using a C0 code, which adds several additional rows representing the column parity symbols. The C0 ECC scheme eliminates the column-wise Code Word Interleaving required in the legacy product-ECC scheme of FIG. 4 and FIG. 5.

In the C0 scheme shown in FIG. 6, the C0 code is a (768, 672) RS code with 10-bit symbols as shown via reference numeral 606. Different examples of data set sizes are described in FIG. 6 via reference numerals 608, 610 based on 10-bit symbols.

Therefore, by using 10-bit symbols in the C0 ECC scheme there is a reduction in storage need while at the same time not affecting the correction power of the ECC schemes used previously.

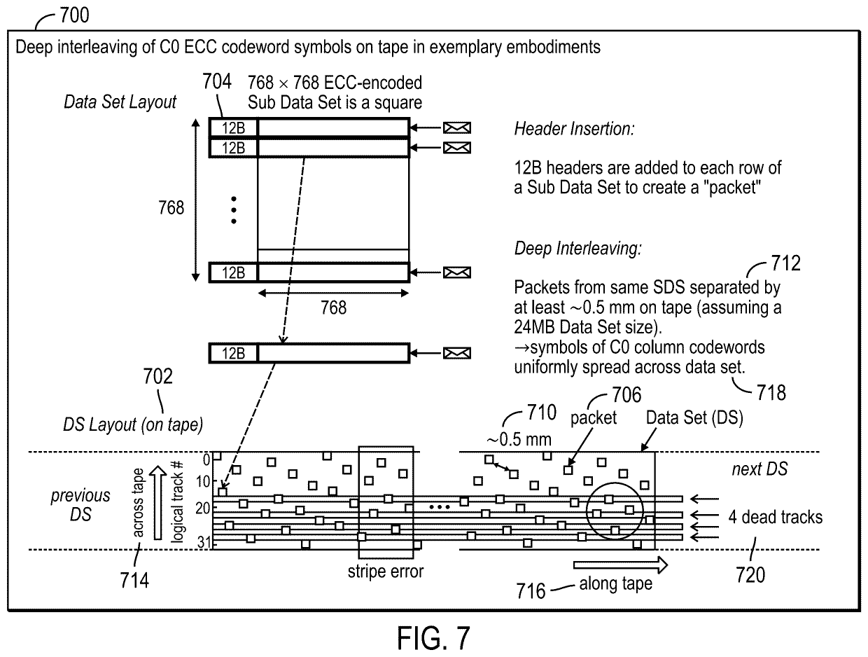

FIG. 7 illustrates a block diagram 700 that shows the deep interleaving of C0 ECC codeword symbols on tape, in accordance with certain embodiments.

The layout of data sets (DS) on tape is shown (reference numeral 702). In FIGS. 7, 12-byte headers (e.g. header 704) are added to each row of a sub data set (SDS) to create a “packet” 706. The code word symbols are interleaved along and across parallel tracks of the tape in the tape drive with reference numeral 714 indicating the distribution across tape and reference numeral 716 indicating the distribution along tape.

Packets from same SDS are separated by at least 0.5 mm on tape (assuming a 24 MB data set size) and this is shown via reference numerals 710, 712, and symbols of C0 column codewords are uniformly spread across the data set as shown via reference numeral 718 and in the DS layout on tape. Note that the physical mapping of packets to tape typically includes additional steps such as e.g. data scrambling/randomization operations, modulation encoding, physical track multiplexing and insertion of synchronization sequences/marks. For simplicity, these physical mapping steps are omitted in FIG. 7.

In certain embodiments, an ECC code rate is at most ⅞ to correct up to 4 out of 32 dead tracks (as shown via reference numeral 720).

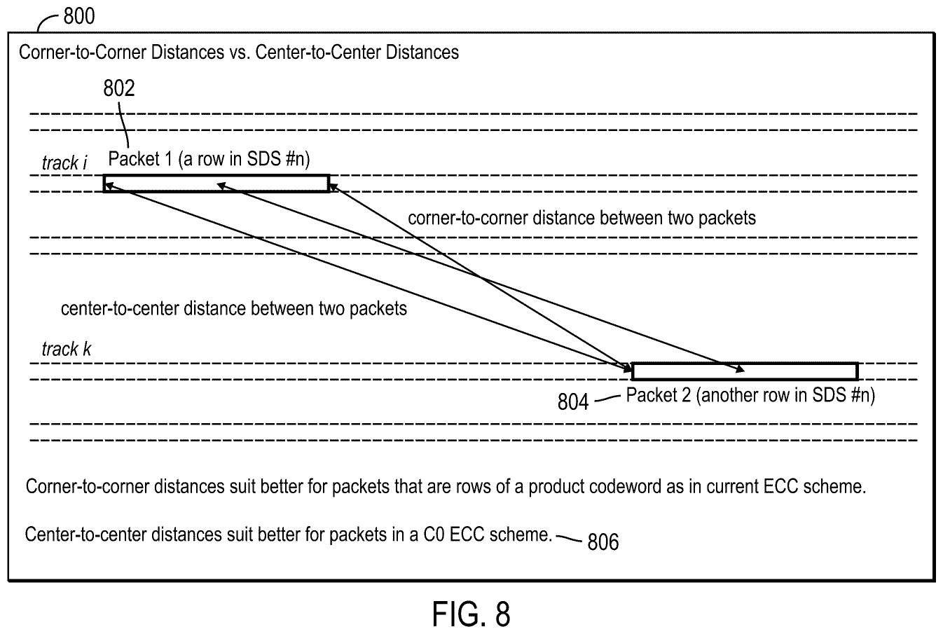

FIG. 8 illustrates a block diagram 800 that shows corner-to-corner distances verses center-to-center distances, in accordance with certain embodiments. Different ways for calculating the distance between two packets 802 and 804 are shown.

It is seen that while corner-to-corner distances are a better metric for packets that are rows of a product codeword as in current ECC schemes, center-to-center distances are a better metric for packets in a C0 ECC scheme (reference numeral 806).

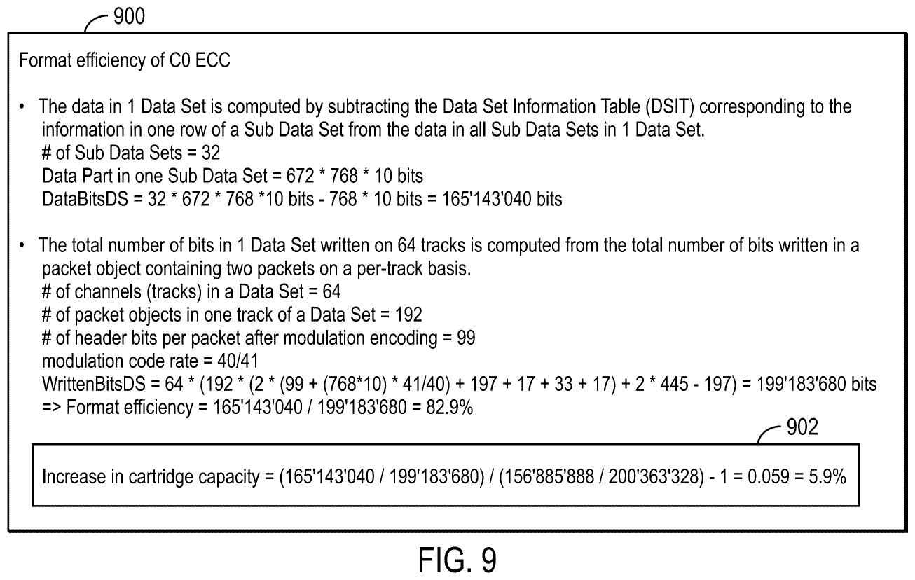

FIG. 9 illustrates a block diagram 900 that shows format efficiency of C0 ECC, in accordance with certain embodiments. In the example shown in FIG. 9, it can be seen that there may be an increase in cartridge capacity of 5.9% as shown via reference numeral 902.

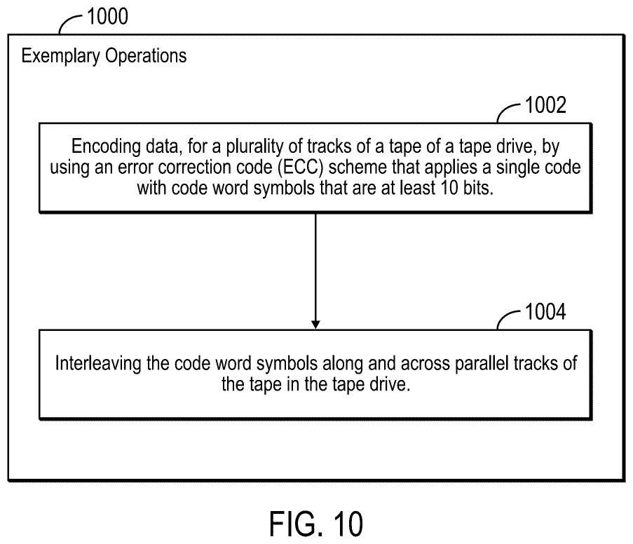

FIG. 10 illustrates a flowchart 1000 that shows exemplary operations, in accordance with certain embodiments. The operations may be performed by a process that executes in the computing environment 100.

Control starts at block 1002 where a process encodes data for a plurality of tracks of a tape 118 of a tape drive 104, by using an error correction code (ECC) scheme that applies a single code with code word symbols that are at least 10 bits. The code word symbols are interleaved (at block 1004) along and across parallel tracks of the tape in the tape drive.

In certain embodiments, the code word symbols are equally distributed along and across the parallel tracks. In further embodiments, an ECC code rate is at most ⅞ to correct up to 4 out of 32 dead tracks. In additional embodiments, the ECC scheme comprises a single Reed-Solomon code with code word symbols of 10 or more bits.

In further embodiments, the tape drive is a multi-track tape drive of 32 or more tracks and includes 64 track tape drives and 128 track tape drives. In yet further embodiments, a minimum physical spacing between the symbols of an ECC code word is of an order of 0.5 millimeter or more. In certain embodiments, an ECC overhead is reduced without degrading burst error correction and random error correction capability of other ECC schemes that are used in tape drives.

Various aspects of the present disclosure are described by narrative text, flowcharts, block diagrams of computer systems and/or block diagrams of the machine logic included in CPP embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instruction.

The described operations may be implemented as a method, apparatus or CPP using standard programming and/or engineering techniques to produce software, firmware, hardware, or any combination thereof. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” The CPP may include a computer readable storage medium (or media) having computer readable program instructions thereon for causing a processor to carry out aspects of the present embodiments.

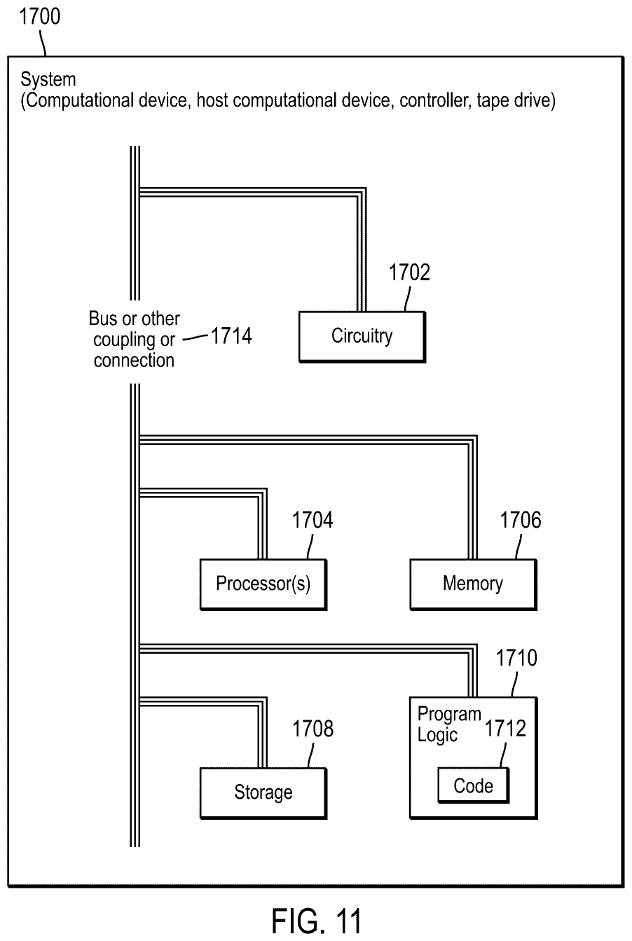

FIG. 11 illustrates a block diagram of a system that shows certain elements that may be included in the tape drive 104, the controller 106, or the host computational device 102 (e.g., computational device), in accordance with certain embodiments. The system 1700 may include a circuitry 1702 that may in certain embodiments include at least a processor 1704. The system 1700 may also include a memory 1706 (e.g., a volatile memory device), and storage 1708. The storage 1708 may include a non-volatile memory device (e.g., EEPROM, ROM, PROM, flash, firmware, programmable logic, etc.), magnetic disk drive, optical disk drive, tape drive, etc. The storage 1708 may comprise an internal storage device, an attached storage device and/or a network accessible storage device. The system 1700 may include a program logic 1710 including code 1712 that may be loaded into the memory 1706 and executed by the processor 1704 or circuitry 1702. In certain embodiments, the program logic 1710 including code 1712 may be stored in the storage 1708. In certain other embodiments, the program logic 1710 may be implemented in the circuitry 1702. One or more of the components in the system 1700 may communicate via a bus or via other coupling or connection 1714. Therefore, while FIG. 11 shows the program logic 1710 separately from the other elements, the program logic 1710 may be implemented in the memory 1706 and/or the circuitry 1702.

Certain embodiments may be directed to a method for deploying computing instruction by a person or automated processing integrating computer-readable code into a computing system, wherein the code in combination with the computing system is enabled to perform the operations of the described embodiments.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

At least certain operations that may have been illustrated in the figures show certain events occurring in a certain order. In alternative embodiments, certain operations may be performed in a different order, modified or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter the invention, the invention resides in the claims hereinafter appended.

IBM is a trademark of International Business Machines Corporation registered in many jurisdictions worldwide.

What is claimed is

1. A method, comprising:
encoding data, for a plurality of tracks of a tape of a tape drive, by using an error correction code (ECC) scheme that applies a single code with code word symbols that are at least 10 bits; and
interleaving the code word symbols along and across parallel tracks of the tape in the tape drive.

2. The method of claim 1, wherein the code word symbols are equally distributed along and across the parallel tracks.

3. The method of claim 1, wherein an ECC code rate is at most ⅞ to correct up to 4 out of 32 dead tracks.

4. The method of claim 1, wherein the ECC scheme comprises a single Reed- Solomon code with code word symbols of 10 or more bits.

5. The method of claim 1, wherein the tape drive is a multi-track tape drive of 32 or more tracks and includes 64 track tape drives and 128 track tape drives.

6. The method of claim 1 wherein a minimum physical spacing between the symbols of an ECC code word is of an order of 0.5 millimeter or more.

7. The method of claim 1, wherein an ECC overhead is reduced without degrading burst error correction and random error correction capability of other ECC schemes that are used in tape drives.

8. A tape drive, comprising:
a controller; and
a tape head coupled to the controller, wherein the controller is configured to perform operations, the operations comprising:
encoding data, for a plurality of tracks of a tape of a tape drive, by using an error correction code (ECC) scheme that applies a single code with code word symbols that are at least 10 bits; and
interleaving the code word symbols along and across parallel tracks of the tape in the tape drive.

9. The tape drive of claim 8, wherein the code word symbols are equally distributed along and across the parallel tracks.

10. The tape drive of claim 8, wherein an ECC code rate is at most ⅞ to correct up to 4 out of 32 dead tracks.

11. The tape drive of claim 8, wherein the ECC scheme comprises a single Reed- Solomon code with code word symbols of 10 or more bits.

12. The tape drive of claim 8, wherein the tape drive is a multi-track tape drive of 32 or more tracks and includes 64 track tape drives and 128 track tape drives.

13. The tape drive of claim 8 wherein a minimum physical spacing between the symbols of an ECC code word is of an order of 0.5 millimeter or more.

14. The tape drive of claim 8, wherein an ECC overhead is reduced without degrading burst error correction and random error correction capability of other ECC schemes that are used in tape drives.

15. A computer program product, the computer program product comprising a computer readable storage medium having computer readable program code embodied therewith, the computer readable program code configured to perform operations in a device, the operations comprising:
encoding data, for a plurality of tracks of a tape of a tape drive, by using an error correction code (ECC) scheme that applies a single code with code word symbols that are at least 10 bits; and
interleaving the code word symbols along and across parallel tracks of the tape in the tape drive.

16. The computer program product of claim 15, wherein the code word symbols are equally distributed along and across the parallel tracks.

17. The computer program product of claim 15, wherein an ECC code rate is at most ⅞ to correct up to 4 out of 32 dead tracks.

18. The computer program product of claim 15, wherein the ECC scheme comprises a single Reed-Solomon code with code word symbols of 10 or more bits.

19. The computer program product of claim 15, wherein the tape drive is a multi-track tape drive of 32 or more tracks and includes 64 track tape drives and 128 track tape drives.

20. The computer program product of claim 15 wherein a minimum physical spacing between the symbols of an ECC code word is of an order of 0.5 millimeter or more.
